(19) United States
(12) Patent Application Publication
(10) Pub. No.: US 2010/0019902 A1
(43) Pub. Date: Jan. 28, 2010

(54) Portable security system and method

(76) Inventor: Willis Jay Mullet, Gulf Breeze, FL (US)

Correspondence Address: J. Nevin Shaffer, Jr. P.A., Suite 43, 913 Gulf Breeze Parkway, Gulf Breeze, FL, 32561, US

(21) Appl. No.: 12/220,567

(22) Filed: Jul. 25, 2008

(51) Int. Cl. G08B 13/08

(52) U.S. Cl. 340/546

(57) ABSTRACT

A portable security system includes a sensing unit where the sensing unit is conformed to sense its own movement and to send a movement signal. An alarm is provided such that the alarm is activated to produce an alarm signal after receipt of the movement signal from the sensing unit.

### FIELD OF THE INVENTION

This invention relates to a portable security system and method. In particular, in accordance with one embodiment, the invention relates, to a portable security system including a sensing unit where the sensing unit is conformed to sense its own movement and send a movement signal. An alarm is provided such that the alarm is activated to produce an alarm signal after receipt of the movement signal from the sensing unit.

### BACKGROUND OF THE INVENTION

There has always been a need for devices and systems that would provide an alert signal of unwanted access into controlled areas, such as hotel or motel rooms and other living spaces in residential and commercial structures. Further, for example only and not by way of limitation, there are occasions that a parent would want to know if a child has managed to open a door and go outside of a structure. There are many known solutions to keeping doors and windows closed and locked but many of those solutions can cause entrapment in the event of a fire. A prior art solution to this problem is the use of alarms to indicate that a door or window is open rather than locking and thereby trapping the individual within the structure. All of these prior art alarm systems known to the Applicant, however, are for electronic systems that are fixed or “hardwired” to the structure which only allows usage in a particular structure within which they are constructed.

By way of example, the prior art known to the Applicant includes devices that require an electronic circuit that is complete when both sides of a specially prepared moveable surface, such as a door or a window, are in a closed position. Opening of the door or window breaks the circuit and causes the system to provide an alarm. U.S. Pat. No. 4,257,038 to Rounds et al., U.S. Pat. No. 5,077,547 to Burgmann, U.S. Pat. No. 6,057,764 to Williams, and U.S. Pat. No. 6,255,944 to Addy exemplify the state of the art of these hard wired “closure detection” systems.

Other prior art solutions include motion detection systems that create an alarm signal in response to motion within or around a “protected” space. Motion detection devices known to the Applicant are exemplified by U.S. Pat. No. 6,798,342 to Addy, U.S. Pat. No. 6,057,764 to Williams (combines closure detection system and motion detection system), and U.S. Pat. No. 5,309,144 to Lacombe et al. exemplify the state of these hard wired “motion detection” systems. The Applicant is also aware of European Patent Application 1447 775 A2 to Delphi Technologies, Inc. for a remote unlocking device with a motion sensor that turns the device off or to an “energy saving mode” when no motion is detected for a period of time.

Still other prior art solutions monitor some particular part of a structure such as the door locks, for example. Such systems are exemplified by U.S. Pat. No. 6,963,210 to Eskildsen, U.S. Pat. No. 7,142,111 Eskildsen et al., and U.S. Pat. No. 7,355,515 Lee et al.. Such hard wired “lock position” systems suffer the same limitations as all the other systems know to the Applicant. That is, the prior art systems are first of all, “hard wired”. As used herein that term includes the ordinary meaning as used in the art. It is a system of wires and circuits that is constructed with or added to a single structure. Once installed it is not meant to be moved. In that sense it is permanent or “hard wired” to a single structure. These prior art systems are, therefore, time consuming to install and expensive. They are also sensitive and subject to break downs and false alarms. Many individuals actually disarm their systems because of the many false alarms they deliver.

Thus, there is a need in the art for a security system that is easy to install and simple to use. Such a system, further, must be accurate and dependable such that “false” alarms are kept to the absolute minimum and the user only receives an alarm signal as a result of a known event. To be competitive, such a system must be inexpensive to install and easily transferable from one structure to another. It, therefore, is an object of this invention to provide a portable security system and method that is easy to install and just as easy to remove and reinstall, that is accurate and adjustable, that is robust and scalable, and that is inexpensive compare to hard wired alternatives.

### SUMMARY OF THE INVENTION

Accordingly, the portable security system of the present invention, according to one embodiment, includes a sensing unit where, when the sensing unit senses movement of itself, it sends a movement signal. An alarm device is provided where the alarm device is activated to produce an alarm signal after receipt of the movement signal from the sensing unit.

By way of example only and not by limitation, again, there has always been a need for devices and systems that would alert inhabitants of unwanted access into controlled areas, such as hotel or motel rooms. Sophisticated alarm systems are not typically provided in these temporarily inhabited spaces but the need for them is perhaps greater there than at home. Thus, a primary element of the present invention is its “portability”. That term is given its ordinary meaning as used herein and describes a system that is transferable quickly and easily from one structure to another and that does not result in damage to the structure either on installation or removal. As such, Applicant's sensing unit and alarm are compact and transportable and easily attachable and removable as will be more fully described hereafter.

Other aspects of the invention include a sensing unit that senses angular movement or a sensing unit that senses linear movement. In another aspect, the sensing unit senses both angular movement and linear movement. In further aspects, the alarm signal is an audio signal or a visual signal. In one aspect, the alarm signal includes both an audio signal and a visual signal. In another aspect, the movement signal includes a below threshold movement signal and the alarm signal includes a below threshold alarm signal. In one aspect, the invention includes an enable/disable transmitter for turning the system on and off.

According to another embodiment of the invention, a portable security system included a sensing unit where, when the sensing unit senses movement of itself, it sends a movement signal according to certain movement parameters. An alarm is provided where the alarm is activated to produce an alarm signal after receipt of the movement signal from the sensing unit. And, an enable/disable transmitter for turning the system on and off is included.

In another aspect of this invention, the movement parameters are preset. In a further aspect, the sensing unit includes controls for setting the movement parameters. In further aspects, the sensing unit is conformed to sense angular movement or linear movement. In another aspect, the alarm signal is selected from a group including: an audio signal and a visual signal. In another aspect, the movement parameters include below threshold parameters and the movement signal includes a below threshold signal and the alarm signal includes a below threshold alarm signal, all as will be more fully described hereafter.

According to another embodiment of the invention, a portable security system method includes the following steps: providing a sensing unit in which the sensing unit, upon sensing movement of itself, sends a movement signal and an alarm where the alarm is activated to produce an alarm signal upon receipt of the movement signal from the sensing unit; connecting the sensing unit with an object; placing the alarm in position to receive the movement signal and activating the alarm such that the alarm activates an alarm signal upon receipt of a movement signal and activating the sensing unit such that upon movement of the object to which the sensing unit is connected, the sensing unit senses its own movement and sends a movement signal to the alarm.

As used herein, the term “object” includes doors, windows, sliding partitions, and the like that move in relation to a “fixed structure”. The fixed structure can be any structure now known, such as, for example only and not by way of limitation, a house, hotel, motel, office building, boat, car, plane or the like or any other fixed structure hereafter developed. The preferred embodiment of the invention is for a portable security device for attachment to movable parts of a structure, such as doors and windows for example, to provide security of and within the structure. Certainly, the invention may be attached to ceilings, walls or other objects not normally associated with movement or designed or intended to move.

In other aspects of the method, the sensing unit is conformed to send a movement signal in accordance with movement parameters selected from a group including: preset movement parameters and manually set movement parameters. In a further aspect, the movement parameters include a below threshold movement parameter such that upon sensing below threshold movement a below threshold movement signal is sent such that a below threshold alarm signal is produced. In another aspect, the movement parameters are selected from a group including: angular movement and linear movement and the alarm signal is selected from a group including: an audio signal and a visual signal.

### DESCRIPTION OF THE DRAWINGS

Other objects, features and advantages of the present invention will become more fully apparent from the following detailed description of the preferred embodiment, the appended claims and the accompanying drawings in which:

FIG. 1 Is a perspective view of a preferred embodiment of the instant invention shown installed on a swinging door;

FIG. 2 Is a side view of the invention of FIG. 1;

FIG. 3 Is a perspective view of the invention of FIG. I shown installed on a sliding door/window;

FIG. 4 Is a schematic of the sensing unit of the present invention according to a preferred embodiment;

FIG. 5 Is a schematic of the alarm module of the present invention according to a preferred embodiment;

FIG. 6 Is a schematic of the enable/disable transmitter of the present invention according to a preferred embodiment;

FIG. 7 Is a setup flowchart illustrating the process for selecting and/or setting the parameters of the invention of FIGS. 1-6; and

FIG. 8 Is an operational flow chart of the operation of the invention of FIGS. 1-7 when connected with an object.

### DETAILED DESCRIPTION OF THE INVENTION

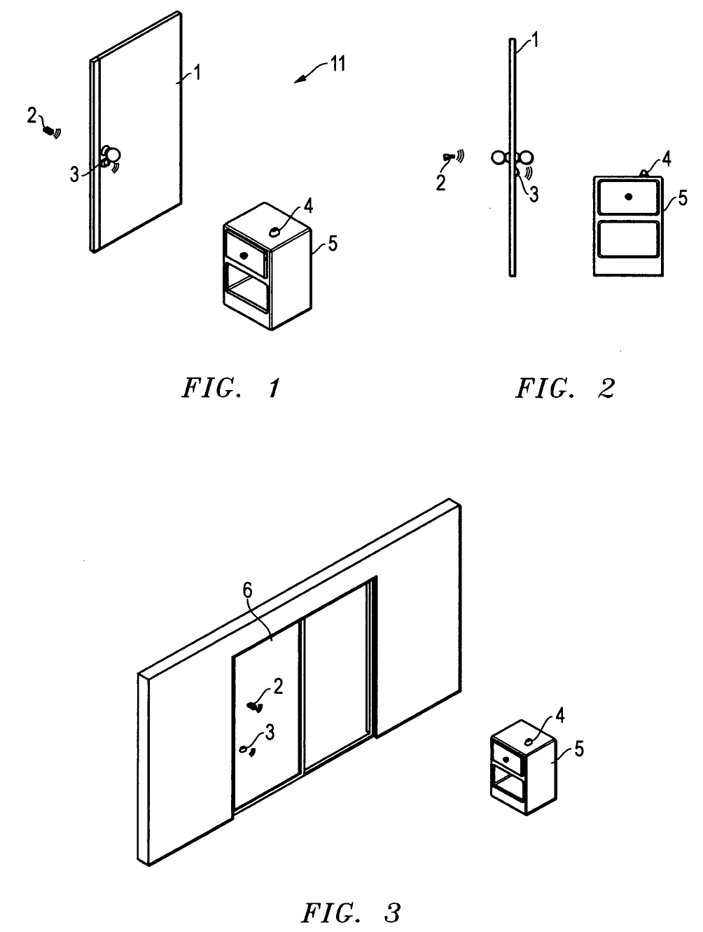

The preferred embodiment of the present invention is illustrated by way of example in FIGS. 1-8. Referring first to FIGS. 1-3, the portable security system 11, according to a preferred embodiment, includes an enable/disable transmitter 2 and a sensing unit 3. As will be discussed in detail hereafter, the sensing unit 3 is intended to be placed on a fenestration such as a door 1 or a window 6. According to the present invention, sensing unit 3 is conformed to send a signal to an alarm 4 when sensing unit 3 senses a change in its position due to a change in the position of the fenestration 1 or 6, for example only. This key feature of the present invention separates it from the prior art devices which themselves do not move and in fact are required to remain stationary in order to properly function.

Sensing unit 3 may be placed on and connected with objects, such as doors 1 or windows 6, by tapes, adhesives, hook and loop systems, tacks, screws, nails, or the like or any other easily used and easily removed attaching device now known or hereafter developed.

Likewise, sensing unit 3 “senses” its own movement by detecting a change in angular position and/or linear position by any means now known or hereafter developed and as will be discussed more fully hereafter.

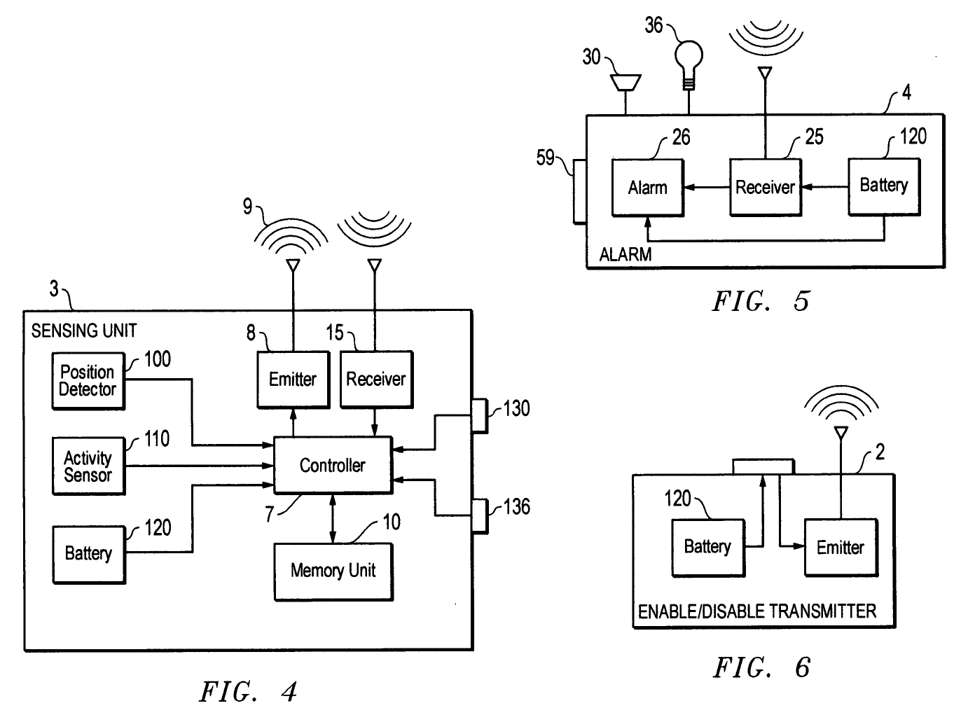

In particular, referring now to FIGS. 4, 5 and 6, the sensing unit 3 includes a signal controller 7 that is configured with the necessary hardware, software, and memory to enable the functions to be discussed. Coupled to the signal controller 7 is an emitter 8 that comprises a transmitter that is capable of generating and transmitting a movement signal 9 that is compatible for receipt by the audio and/or visual alarm 4. The sensing unit 3 also includes a memory unit 10 that is coupled to the controller 7. The memory unit 10 may comprise volatile memory, non-volatile memory, or a combination of both. In one aspect, the memory unit 10 may store various predetermined values, including an angle threshold value and/or a distance threshold value. The memory may also store factory preset values for angle change and distance values. In addition, the memory unit 10 together with the controller 7 facilitates generation of the appropriate data to include in the movement signal 9 inasmuch as one sensing unit 3 may be associated with multiple alarms 4 or in the event multiple sensing units 3 are associated with a single alarm 4. In other words, the controller 7 is able to distinguish the movement signals 9 of different sensing units 3 and act upon them accordingly.

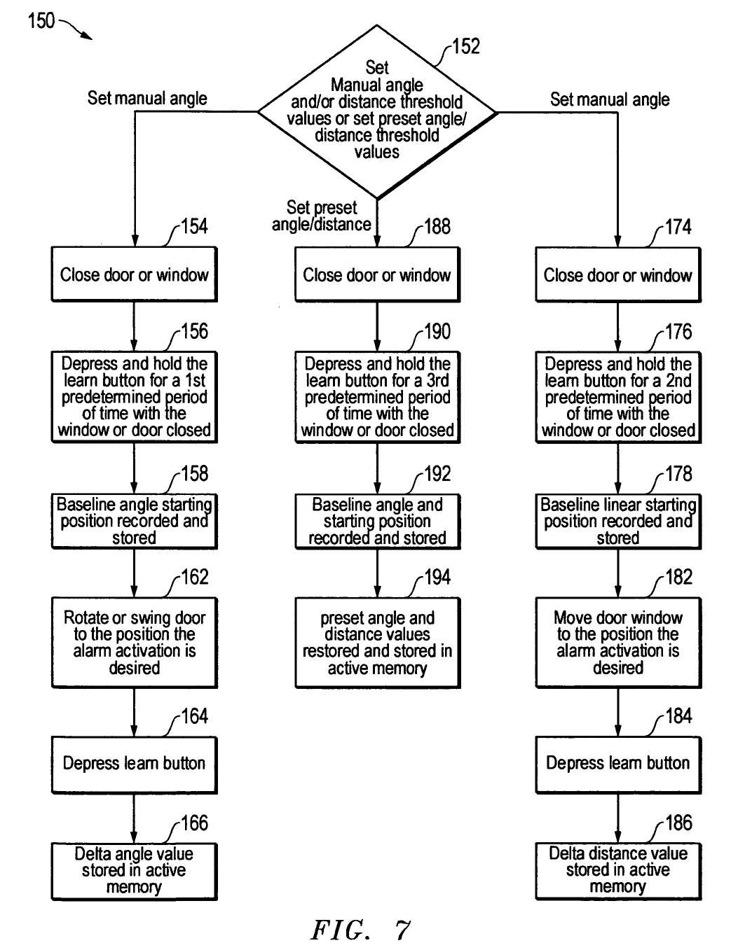

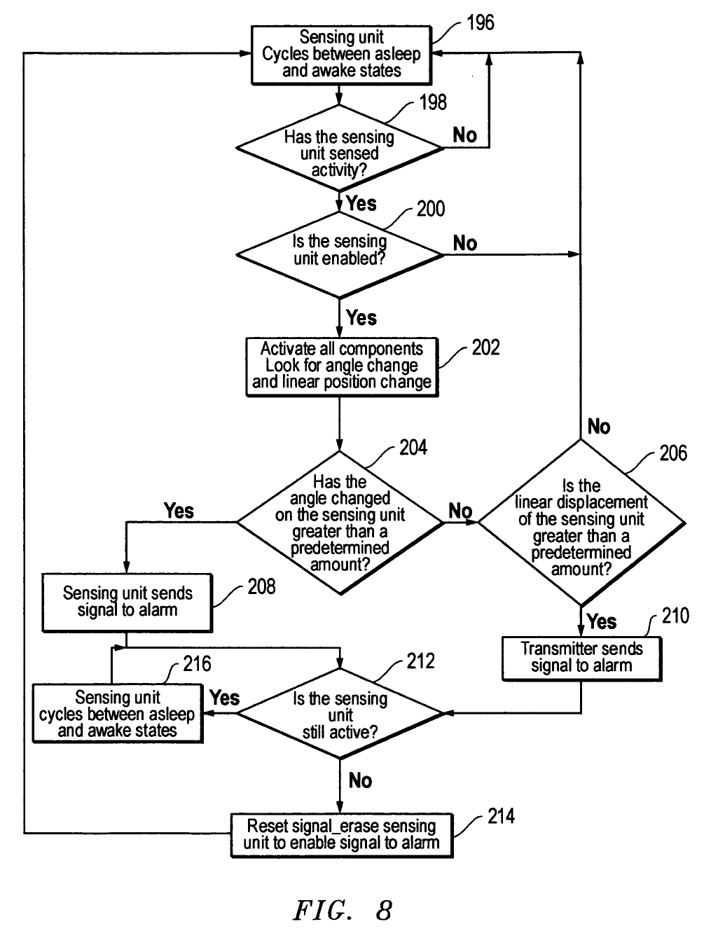

The preferred elements the Applicant uses to monitor the movement of the sensing unit 3 includes a position detector 100 and an activity sensor 110, each of which are coupled to the controller 7. The position detector 100 may comprise a digital compass, an analog compass, a two-axis compass, a tilt switch, and/or an accelerometer as well as any other device suitable for detecting positional or angular change, and any combination of the foregoing devices and generating a corresponding angle position signal. If an accelerometer is included in the position detector 100, it can be a multi-axis accelerometer, which is configured to detect changes in acceleration in the X, Y, and Z directions. The position detector 100 is primarily used to detect a change in angular orientation, but in some embodiments the position detector 100 may also detect a change in linear position. The position detector 100 serves as a position detector allowing the sensing unit 3 to determine when it itself has changed its positional orientation with respect to a predetermined angle threshold value and/or a linear distance threshold value stored at the memory unit 10. As such, when the angular position or linear distance exceeds that identified by the predetermined threshold values, the sensing unit 3 automatically sends a movement signal 9 to alarm 4 which commands the alarm 4 to activate. In operation, sensing unit 3 is simply placed on the movable part of a door 1 or window 6, and, once activated as will be discussed more fully with regard to FIGS. 7 and 8, it communicates with the alarm 4 for the purpose of automatically signaling an audio or visual warning as a result of its own movement due to the change in angular position and/or change in linear movement of the window 6 or door 1.

The activity sensor 110 is configured to detect whether the window 6 or door 1 is active—in an on condition or moving—and may comprise an accelerometer, such as a multi-function accelerometer that can detect changes in acceleration in the X, Y, Z directions. An accelerometer is believed to be ideally suited to determine linear displacement, although the previously mentioned devices described above could also be used.

The sensing unit 3 also preferably includes a replaceable or rechargeable battery 120 that is configured to provide power to the various components comprising the sensing unit 3 as described herein.

It is also contemplated that the sensing unit 3 may also include a learn button 130 and an on/off button 136 that provide various functions to be discussed below. In one aspect, the learn/door move button 130 when actuated in accordance with a predetermined sequence enables the sensing unit 3 to be “learned” to the alarm 4 when the alarm 4 is placed in a “learn” mode after the learn button 59 of the selected alarm 4 has been actuated. Alternatively, when the on/off button 136 is placed in to the “off” state, the features provided by the sensing unit 3 are disabled, such that the receiver 15 will no longer receive signals from the enable/disable transmitter 2 until the on/off button 136 is placed into the “on” state. It is also contemplated that the actuation of the learn button 130 and the on/off button 136 allows the controller 7 to be programmed with updated angle threshold and/or linear distance threshold values for storage at the memory unit 10. For example, the angle threshold value may be programmed to comprise a value of at least 15 to 45 degrees for example only and not by way of limitation, although any suitable angle may be used, whereas the linear distance threshold value may be programmed to comprise a value between about 1 to 15 inches, again for example only, although any suitable distance may be used. Re-programming of the threshold values may be done wirelessly, or the controller 7 and/or the memory unit 10 may be provided with a port (not shown but as known in the art) that allows for direct re-programming.

Referring particularly to FIG. 5, it is also contemplated that the alarm 4 may include an audio source 30 and/or a light source 36 such as a light-emitting diode, for example only. It is envisioned that the audio source 30 and/or the light source 36 may be employed to provide audio or verbal alarms or light indications as to certain events that need the immediate attention of the person utilizing the sensing unit 3. The audio and light sources 30 and 36 may also provide confirmation or rejection of the attempted programming or learning functions invoked by the buttons 130 and 136.

Further, the alarm unit 4 shown in FIG. 5 preferably contains a battery 120, a receiver 25, a multi-tone alarm 26, a speaker 30, a light source 36, and a cancel button 59. Further, the alarm 4 can receive signals from the enable/disable transmitter 2 shown in FIG. 6 to enable the alarm 4 or disable the alarm 4 as needed. It can also receive signals from the sensing unit 3, but which, if in the disable mode, will ignore the signal. However, if the alarm 4 is in the enable mode it will respond to the movement signals 9 it receives as discussed herein. The cancel button 59 on alarm 4 allows the user to cancel any alarm activity.

According to a preferred embodiment, with the structural and functional aspects of the portable security system 11 as set forth above, the operational steps to be taken to establish the “threshold” positional (angle and distance) values used by the sensing unit 3 are indicated generally by the numeral 150 in FIG. 7. Initially at step 152, the user of the sensing unit 3 determines whether to manually set the threshold angle value, the threshold distance value, or to use a preset profile to automatically calculate the threshold angle and threshold distance values. The threshold positional (angle and distance) values to initiate a signal can be preset from the factory as known in the art.

If the user elects to manually set the threshold angle value, the user initially attaches the sensing unit 3 to and object such as a window 6 or door 1 and moves the door 1 or window 6 to the “closed” position as indicated at step 154. Obviously, this “closed” position is the normal position of a door or window but certainly it is to be understood as simply a “first” position. Next, at step 156 the user depresses and holds the learn button 130 of the sensing unit 3 for a first predetermined amount of time to invoke the baseline angle detection mode indicated at step 158. However, it should be appreciated that the baseline angle detection mode may be entered using a variety of techniques, including depressing the learn button 130 and/or on/off button 136 in a predetermined sequence, or any other unique manner of indicating that the mode of step 158 is to be initiated. Next, the baseline angle of the door or window is generated by the position detector 100, identified and then stored at the sensing unit 3, as indicated at step 158. After step 158 is performed, the door 1 or window 6 now carrying the signal transmitter 3 is moved to a position, a “second” position usually associated with an “open” door 1 or window 6, where the user desires the alarm to be activated, as indicated at step 162. Once the door 1 or window 6 carrying the sensing unit 3 is moved to the desired position, the process continues to step 164, where the learn button 130 is depressed, and the current angle value associated with the position of the sensing unit 3, and concurrently of the door or window carrying the sensing unit 3, established in step 162 is generated by the position detector 100, identified and then stored in the memory unit 10. At step 166, the sensing unit 3 calculates and stores the threshold angle value based on the change in magnitude of the angle between the baseline and current angle values identified at steps 158 and 166.

Alternatively, if the user desires to manually set the threshold distance value, the user initially attaches the sensing unit 3 to an object, again such as the door 1 or window 6, moves the door 1 or window 6 to the “closed” position as indicated at step 174. Next, at step 176 the user depresses and holds the learn button 130 of the sensing unit 3 for a second predetermined amount of time, which is different from the amount of time used in step 156, while the door or window is in the closed position to invoke the baseline distance detection mode indicated at step 178.

However, it should be appreciated that the baseline distance detection mode may be entered using a variety of techniques, including depressing the learn button 130 and/or on/off button 136 in a predetermined sequence, or any other unique manner of indicating that the mode of step 178 is to be initiated. Next, the baseline position or starting point or first position is identified by the activity sensor 110, or in some embodiments the position detector 100 and stored in the memory unit 10, as indicated at step 178. After step 178 is performed, the door 1 or window 6 carrying the sensing unit 3 is moved to a position where the user desires the alarm to activate, a second position, as indicated at step 182. Once the door I or window 6 carrying sensing unit 3 is moved to the desired second position, the process continues to step 184, where the learn button 130 is depressed, and the current position of the sensing unit 3 established in step 182 is identified by the activity sensor 110 or by the position detector 100 and stored in the memory unit 10. At step 186, the sensing unit 3 calculates and stores the threshold distance value based on the distance that is between the baseline starting position and the current position values identified at steps 176 and 184.

The user may also decide to use preset values that have been pre-programmed into the sensing unit 3 to set the threshold angle and distance values. To set such values, the user initially attaches the sensing unit 3 to the object, a door 1 or window 6, to be monitored and moves the door 1 or window 6 to the closed position as indicated at step 188. Next, at step 190 the user depresses and holds the learn button 130 of the sensing unit 3 for a third predetermined amount of time, which is different from the amount of time used in steps 156 and 176, while the door 1 or window 6 carrying the sensing unit 3 is in the closed position to invoke the baseline angle and distance detection mode indicated at step 192. However, it should again be appreciated that the baseline angle and distance detection mode may be entered using a variety of techniques, including depressing the learn button 130 and/or on/off button 136 in a predetermined sequence, or any other manner of indicating that the mode of step 192 is to be initiated. Next, the factory preset angle and distance values stored in the memory unit 10 of the sensing unit 3, are recalled and set in the controller 7 as indicated at step 194. That, is the sensing unit 3 utilizes the pre-programmed criteria, such as a predetermined angular or positional change from the identified baseline values to calculate the threshold angle and threshold distance values, which are then stored in the sensing unit 3.

While the operational steps 150 set forth above are indicative of one manner of implementing the identification of the threshold angle and distance values, such should not be construed as limiting, as such process or sequence may be readily modified or altered using known techniques, while still retaining the general functionality of the process 150.

Referring now to FIG. 8, the operation of the portable security system 11 of the present invention is described. Once located on an object, as set forth above, at block 196 the sensing unit 3 is conformed to cycle between asleep and awake states. At block 198 it determines if the sensing unit 3 has sensed movement of itself or “activity”. If no, it recycles back to block 196. If yes, it continues to block 200 where it is determined if the sensing unit 3 is enabled or on. If no, it recycles back to block 196. If yes, it proceeds to block 202 where all components of sensing unit 3 are activated and a determination of whether or not a change in angular and/or linear position is made.

It should be understood that the sensing unit 3 can have the capability to send different signal to the alarm unit 4. In one case, if there is only slight movement of the door I or window 6 carrying the sensing unit 3, such as wind or noise created movement, the movement signal 9 could send a below threshold signal 9 and the alarm unit 4 responds by emitting a below threshold audio 30 and/or visual 36 alarm signal such as a low tone beep, chirp or a visual warning such as a light that glows at a reduced out put. In the case of the opening being breached with the door I or window 6 movement reaching its alarm signaling values, however, then a second movement signal 9 is sent which results in activation of the full visual and/or audible alarm signals.

Still referring to FIG. 8, at block 204 it is determined whether the angular position has changed more than a predetermined amount. If no, at block 206 it is determined whether the linear position has changed more than a predetermined amount. If no, it recycles to block 196. If yes, at block 208 and/or 210 a movement signal 9 (alarm signal) is sent to alarm 4. Thereafter, at block 212 it is determined if the sensing unit 3 is still active. If no, it proceeds to block 214 a reset signal is entered and the system returns to block 196. If yes, at block 216 the sensing unit 3 recycles between awake and asleep.

The description of the present embodiments of the invention has been presented for purposes of illustration, but is not intended to be exhaustive or to limit the invention to the form disclosed. Many modifications and variations will be apparent to those of ordinary skill in the art. As such, while the present invention has been disclosed in connection with an embodiment thereof, it should be understood that other embodiments may fall within the spirit and scope of the invention as defined by the following claims.

What is claimed is:

1. A portable security system comprising:
a. a sensing unit wherein said sensing unit senses movement of itself and sends a movement signal; and
b. an alarm wherein said alarm is activated to produce an alarm signal after receipt of said movement signal from said sensing unit.

2. The system of claim 1 wherein said sensing unit senses angular movement.

3. The system of claim 1 wherein said sensing unit senses linear movement.

4. The system of claim 1 wherein said sensing unit senses both angular movement and linear movement.

5. The system of claim 1 wherein said alarm signal is an audio signal.

6. The system claim 1 wherein said alarm signal is a visual signal.

7. The system of claim 1 wherein said alarm signal includes an audio signal and a visual signal.

8. The system of claim 1 wherein said movement signal includes a below threshold movement signal and said alarm signal includes a below threshold alarm signal.

9. The system of claim 1 further comprising an enable/disable transmitter for turning said system on and off.

10. A portable security system comprising:
a. a sensing unit wherein said sensing unit senses movement of itself and sends a movement signal according to movement parameters;
b. an alarm wherein said alarm is activated to produce an alarm signal after receipt of said movement signal from said sensing unit; and
c. an enable/disable transmitter for turning said system on and off.

11. The system of claim 10 wherein said movement parameters are preset.

12. The system of claim 10 wherein said sensing unit includes controls for setting said movement parameters.

13. The system of claim 10 wherein said sensing unit senses angular movement.

14. The system of claim 10 wherein said sensing unit senses linear movement.

15. The system of claim 10 wherein said alarm signal is selected from a group comprising: an audio signal and a visual signal.

16. The system of claim 10 wherein said movement parameters include below threshold parameters and said movement signal includes a below threshold signal and said alarm signal includes a below threshold alarm signal.

17. A portable security system method comprising:
a. providing a sensing unit wherein said sensing unit, upon sensing movement of itself, sends a movement signal and an alarm wherein said alarm is activated to produce an alarm signal upon receipt of said movement signal from said sensing unit;
b. connecting the sensing unit with an object;
c. placing the alarm in position to receive said movement signal and activating said alarm such that said alarm activates said alarm signal upon receipt of said movement signal; and
d. activating said sensing unit such that upon movement of said object to which said sensing unit is connected, said sensing unit senses its own movement and sends a movement signal to said alarm.

18. The method of claim 17 wherein said sensing unit sends a movement signal in accordance with movement parameters selected from a group comprising: preset movement parameters and manually set movement parameters.

19. The method of claim 17 wherein said movement parameters include a below threshold movement parameter such that upon sensing below threshold movement a below threshold movement signal is sent such that a below threshold alarm signal is produced.

20. The method of claim 18 wherein said movement parameters are selected from a group comprising: angular movement and linear movement and said alarm signal is selected from a group comprising: an audio signal and a visual signal.
